(19) United States
(12) Patent Application Publication
(10) Pub. No.: US 2014/0124655 A1
(43) Pub. Date: May 8, 2014

(54) UV LED LIGHTBAR FOR SETTING A UV-CURABLE NAIL FORMULATION

(71) Applicant: Coty Inc., New York, NY (US)

(72) Inventors: Rene Thomas Rivero, West New York, NJ (US); Virginia K. Coners, Succasunna, NJ (US); Gerardo Flasz, Brewster, NY (US); Donald Langstaff Reifsnyder, Rye, NY (US); Joshua K. Blair, Hastings on Hudson, NY (US); Heather Anne Brandell, Annandale, NJ (US); Ralph Anthony Macchio, Sparta, NJ (US)

(73) Assignee: Coty Inc., New York, NY (US)

(21) Appl. No.: 14/073,370

(22) Filed: Nov. 6, 2013

Related U.S. Application Data
(60) Provisional application No. 61/723,151, filed on Nov. 6, 2012.

(51) Int. Cl. B29C 35/08

(52) U.S. Cl. CPC B29C 35/0805
USPC 250/208.1; 250/492.1

(57) ABSTRACT

Various systems and methods for implementing a UV LED lightbar for setting a UV-curable nail formulation are described herein. A lightbar comprises a detachable UV lightbar comprising a plurality of UV lights with at least two of the plurality of UV lights having different UV light output; and a connector for connection to a power supply, where the detachable UV lightbar is controlled by a controller connectably attachable to the connector, the controller configured to control the plurality of UV lights in a manner to cure a nail gel preparation. A method for curing a nail gel preparation comprises identifying by a processing device, the nail gel preparation; and configuring an UV light assembly to cure the nail gel preparation.

### RELATED APPLICATIONS

This application claims the benefit of priority to U.S. Provisional Patent Application Ser. No. 61/723,151, filed Nov. 6, 2012, which is hereby incorporated by reference herein in its entirety

### TECHNICAL FIELD

The present disclosure relates generally to curing nail preparations and in particular to an ultraviolet (UV) light emitting diode lightbar for setting a UV-curable nail formulations.

### BACKGROUND

A gel artificial nail product is a premixed gel of chemically reactive monomers and oligomers (strings of monomers) that is applied to the nail and then cured. An acrylic artificial nail product is a mixture of a liquid and a powder. Most acrylic artificial nails polymerize by way of ambient heat. Some acrylic artificial nails use UV light to initiate the polymerization process. UV light causes a chemical reaction in acrylics and gels that result in the formation of a long-lasting, highly-durable nail coating. Artificial nails may possess enhanced adhesion, durability, scratch resistance, and solvent resistance compared to lacquer or enamel nail polishes.

Under-curing or over-curing gel applications are each problematic for different reasons. An under-cured gel application may have a sticky, gummy top surface. If lower portions of the gel strata are uncured, the whole gel application may be prone to staining, discoloration, lifting, breakage, or causing allergic reactions. An over-cured gel application may overheat and burn the underlying nail bed.

Thus, there is a need to provide a UV lamp for curing acrylics and gels with the proper UV light intensity and duration to avoid over or under-curing applications.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1A is a prospective view of a lighting device, according to an embodiment;

FIG. 1B is an alternative prospective view of the lighting device, according to an embodiment;

FIG. 2 is a schematic view of the lighting device and a control device, according to an embodiment;

FIG. 3A is a prospective view of the lighting device attached to a mobile electronic device, according to an embodiment;

FIG. 3B is an alternative prospective view of the lighting device attached to a mobile electronic device, according to an embodiment;

FIG. 4 is a flowchart illustrating a method for curing a nail gel preparation, according to an embodiment;

FIG. 5 is a flowchart illustrating a method for curing a nail gel preparation, according to an embodiment; and

FIG. 6 is a block diagram illustrating a machine in the example form of a computer system, within which a set or sequence of instructions may be executed to cause the machine to perform any one of the methodologies discussed herein, according to an example embodiment.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments.

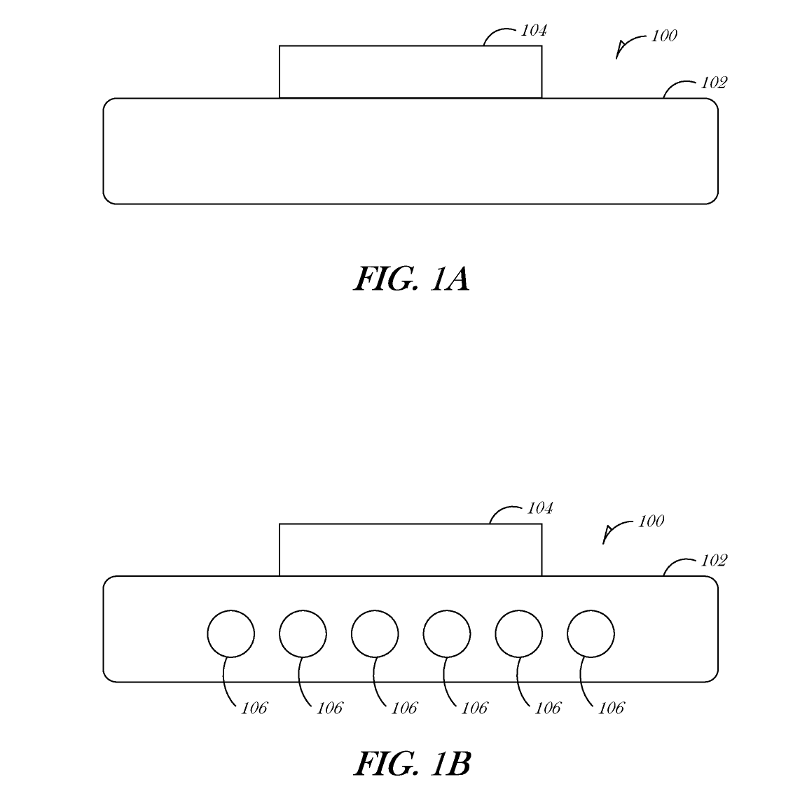

FIG. 1A is a prospective view of a lighting device 100, according to an embodiment. The lighting device 100 includes a housing 102 and a connector 104. The housing 102 may be of any suitable construction or configuration, including but not limited to plastic, metal, alloys, ceramic, polymer, carbon fibers, or combinations thereof. The housing 102 is configured to support and contain at least one UV light and at least one connector, such as connector 104. The connector 104 is configured to provide a connection to another device (not shown) and transmit data, power, or control signals to and from the other device. In an embodiment, the connector 104 is a 30-pin connector compatible with devices offered and produced by APPLE® INC. of Cupertino, Calif. In other embodiments, the connector 104 is a universal serial bus (USB) connector, a mini-USB connector, a micro-USB connector, a high-definition multimedia interface (HDMI) connector, a mini-dock connector produced by APPLE® INC., or the like.

FIG. 1B is an alternative prospective view of the lighting device 100, according to an embodiment. FIG. 1B illustrates the opposite side of the lighting device 100 and includes at least one UV light 106. In the example illustrated in FIG. 1B, six UV lights 106 are shown. The UV lights 106 may be of any suitable construction, such as a light-emitting diode (LED), cold cathode lamp, or a compact florescent lamp (CFL). In addition, while six UV lights are shown in FIG. 1B, it is understood that more or fewer lights may be used. In various embodiments discussed herein, the UV light assembly of FIGS. 1A and 1B is referred to as a “lightbar.” Although not illustrated, it is understood that various modifications may be made to the lighting device 100, such as by incorporating or allowing for a shield to be attached to the lighting device 100 in order to protect the operator's eyes or skin from exposure. The shield may be constructed from plastic, metal, or other types of material or combinations of materials configured to block the wavelengths emitted from a UV light. In an embodiment, the shield is translucent or transparent, in order for the operator to be able to observe the curing process. In addition, the lighting device 100 may incorporate or allow for a base to be attached. The base may be used to provide easier operation for the operator. Further, the base may be configured and constructed of light absorbing material to reduce the amount of reflected UV light. The base may be fixed or adjustable in height, but is preferably configurable to adapt to a distance of approximately one inch from the top of the operator's nails.

In an embodiment, the lighting device 100 includes a plurality of UV lights, with at least some of the UV lights having different operational peak wavelengths. Various nail products are designed in a manner that some wavelengths operate to cure the product faster than others. It is understood that LED UV lights operate in a relatively narrow spectrum, such that a LED UV light rated at 395 nm may output light in the 390-400 nm range. Thus, the use of multiple wavelengths is advantageous in order to cure nail products at an efficient intensity. In an embodiment, a lightbar may include four LED UV lights that operate at a 340 nm wavelength and four LED UV lights that operate at 395 nm wavelength.

In an embodiment, the device includes a plurality of UV lights, with at least two of the lights being of different design. For example, a lightbar may include five LED UV lights operating a specific wavelength (e.g., 395 nm) and one CFL operating over a range of wavelengths (e.g., 320-360 nm). In this configuration, one product that cures at 395 nm may be cured using the LED UV lights, while another product that cures at 330 nm may be cured using the CFL.

FIGS. 1A and 1B illustrate a lightbar that is connectable to a portable or stationary power source. The power source may be any type of power source, including but not limited to a battery, fuel cell, solar power system, generator, an alternating current (AC) power supply, or a direct current (DC) power supply. The power source may be a discrete, stand-alone device (e.g., an AC converter) or an integrated device (e.g., a batter in a mobile phone).

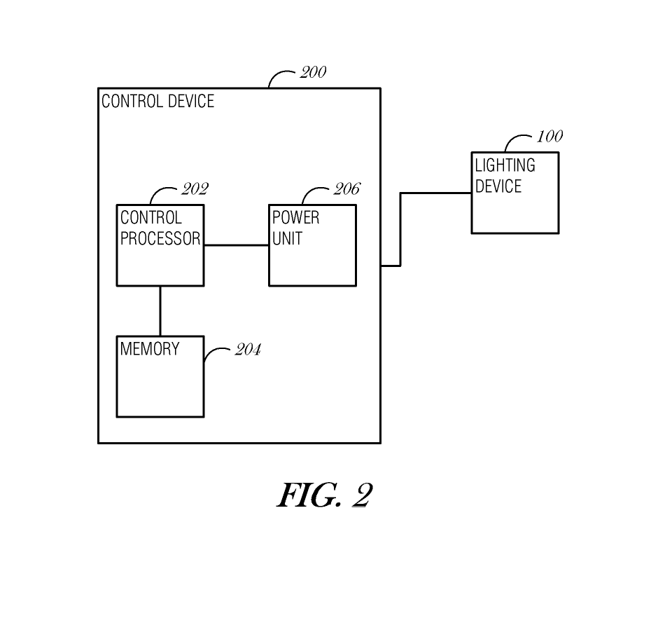

FIG. 2 is a schematic view of the lighting device 100 and a control device 200, according to an embodiment. The control device 200 includes a control processor 202, a memory 204, and a power unit 206. The lighting device 100 is coupled to the power unit 206, such as by way of a 30-pin connector, a USB, or a HDMI connection. The lighting device 100 is also coupled to the control processor 202, such as by way of the connection. The control processor 202 may implement instructions stored in memory 204 in order to control the operation of lighting device 100. Control of the lighting device 100 by the control processor 202 may include operations such as activating or deactivating one or more lights on the lighting device 100, increasing or decreasing the light output or intensity of one or more lights on the lighting device 100, or operating a light in a specific manner, such as strobing. Additionally, the control processor 202 may maintain one or more timers to control the length of operation of one or more lights on the lighting device 100.

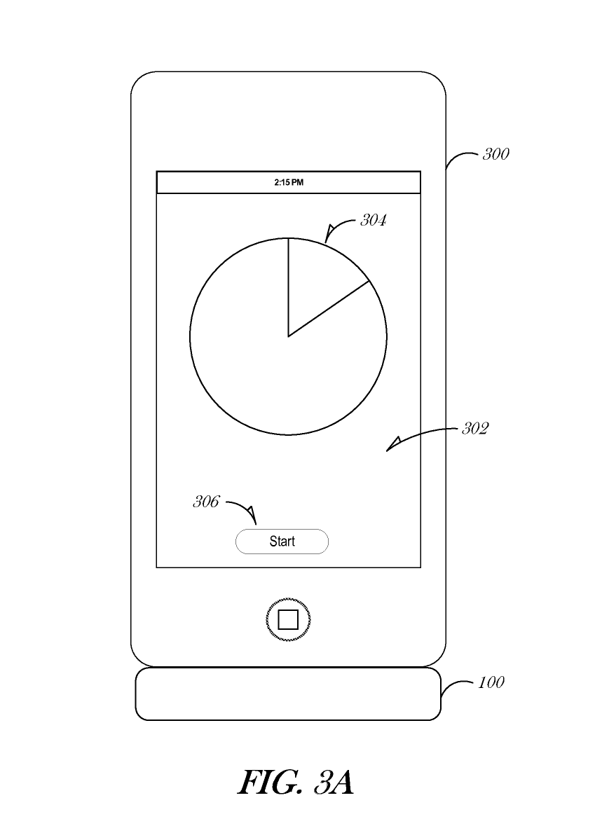

FIGS. 3A and 3B illustrate a specific implementation of the control device 200 (of FIG. 2), according to an embodiment. FIG. 3A is a prospective view of the lighting device 100 attached to a mobile electronic device 300, according to an embodiment. The mobile electronic device 300 illustrated in FIG. 3A is a mobile phone. It is understood that other types of mobile electronic devices may be used, such as personal digital assistants (PDAs), electronic book readers, tablet computers, smart phones, personal entertainment devices, or other portable electronic devices. The mobile electronic device 300 includes a display screen 302. The display screen 302 may be a touchscreen display allowing a user to control the mobile electronic device 300 by interacting with what is displayed o the display screen 302. The display screen's 302 touchscreen may be implemented in various ways, including but not limited to using a capacitive touchscreen panel, a resistive touchscreen panel, or an infrared touchscreen mechanism.

In the example illustrated in FIG. 3A, a timer 304 and a start button 306 are displayed on the display screen 302. The timer 304 indicates approximately how long a person needs to expose gel-treated nails to the UV lights on the lighting device 100 in order to cure the gel. The start button 306 is used to begin the timer's countdown.

The mobile electronic device 300 includes a processor and software to control the lighting device 100. The software may be provided by the distributor or manufacturer of the lightning device 100. In an embodiment, the software is branded to identify the source of the software as being the same as the lighting device 100. The lightning device 100 may be provided by the same company that produces or provides the nail product.

FIG. 3B is an alternative prospective view of the lighting device 100 attached to a mobile electronic device 300, according to an embodiment. In particular, FIG. 3B illustrates the “back” or “underside” of the mobile electronic device 300. The lights 106 on the lighting device 100 are visible from this perspective. In addition, a sensor 308 is illustrated. In an embodiment, the sensor 308 includes a camera. In other embodiments, the sensor 308 may include devices such as a radio-frequency identification (RFID) reader or an optical scanner (e.g., bar code reader). A light 310 is also illustrated in FIG. 3B. The light 310 may typically be used for illuminating a photograph or video and may be referred to as a “flash.” In an embodiment, the light 310 is configurable or configured to emit UV light and the mobile electronic device 300 is configurable to cure an application of nail polish using the light 310.

During operation, a user may scan a box or a product container to obtain a product code. For example, the user may scan a bar code printed on a product container. The bar code may be a linear bar code (e.g., Universal Product Code (UPC)) or a two-dimensional bar code (e.g., QR Code). Once the product code is identified, the timer 304 may be configured appropriately for the corresponding product. In this manner, a user is exposed to an appropriate amount of UV light, where overexposure or underexposure may be harmful or produce unintended results. To avoid accidental exposure, in an embodiment, during operation, the mobile electronic device or the lighting device may be configured to shut off UV lights when the angle of the respective device deviates on the x-y axis more than a threshold angle from horizontal. In an embodiment, the threshold angle is 40 degrees. In another embodiment, the threshold angle is configurable, such as by the operator of the device. Other operations are discussed below.

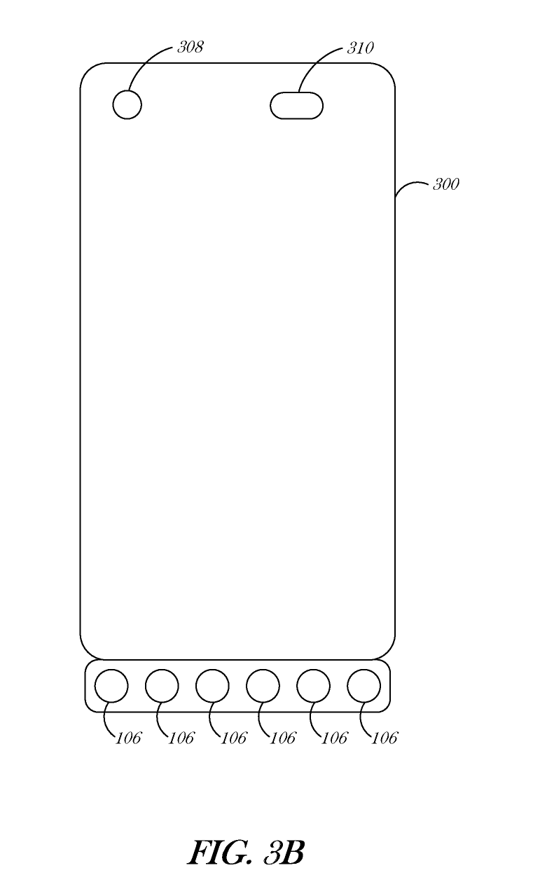

FIG. 4 is a flowchart illustrating a method 400 for curing a nail gel preparation, according to an embodiment. At block 402, the nail gel preparation is identified. In an embodiment, identifying the nail gel preparation includes obtaining an image of a product container for the nail gel preparation, identifying a product code from the image, and using the product code to determine a curing configuration for the nail gel preparation. In such an embodiment, configuring the UV light assembly includes using the curing configuration. Although use of a product code is described herein, it is understood that other identifying indicia may be used, such as a product name, formulation type identification, or other unique or distinguishing identifier.

In a further embodiment, identifying the product code from the image includes identifying and parsing a bar code contained in the image to obtain the product code. The bar code may be isolation in an image and analyzed in software. In another embodiment, the user is prompted to identify the gel preparation. In such an embodiment, identifying the nail gel preparation includes receiving user input to identify the nail gel preparation.

In a further embodiment, using the product code to determine a curing configuration includes transmitting the product code to a remote data store with a query to obtain the curing configuration and receiving the curing configuration from the remote data store. The remote data store may include a manufacturer's system (e.g., a web page maintained by a manufacturer of a gel nail product). The curing configuration may be transmitted in a standardized format, such as in extensible markup language (XML). The curing configuration may include one or more parameters, such as length of curing and optimal UV light wavelength. In an embodiment, the curing configuration comprises a cure time. In an embodiment, the curing configuration comprises a target wavelength. The target wavelength is the wavelength of UV light that the formulation was designed for. Although other wavelengths may work to eventually cure the formulation, cure times may be inconveniently extended and the formulation may not cure in the manner in which it was designed.

At block 404, an ultraviolet (UV) light assembly is configured to cure the nail gel preparation.

In a further embodiment, the method 400 comprises displaying a presentation to a user of the processing device substantially contemporaneously with curing the nail gel preparation. In an embodiment, the presentation includes a timer, the timer indicating an approximate time left to cure the nail gel preparation. In an embodiment, the presentation comprises at least one of: an advertisement or a tip. The advertisement may be for similar or related products (e.g., an up-sell or a cross-sell). Alternatively, the advertisement may be for other items that the user may be interested in purchasing, where such items are derived from various data including user location or user demographic data (e.g., age, gender, marital status, employment status, etc.). Tips may include information related to nail care, application of products to nails, or other instructions related to beauty products. In an embodiment, an advertisement or tip is selected with a length approximately equal to the time to cure the nail gel preparation. In this manner, the user is provided information or entertained during the curing process.

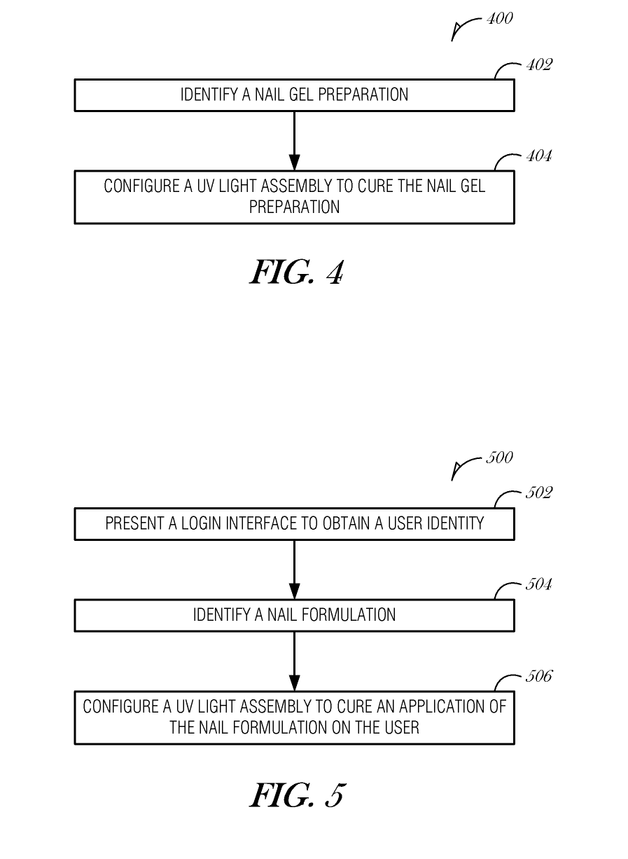

FIG. 5 is a flowchart illustrating a method 500 for curing a nail gel preparation, according to an embodiment. At block 502, a login interface is presented to obtain a user identity of a user of the computer. The login interface may be incorporated into the software that controls the UV light assembly.

At block 504, a nail formulation is identified. The nail formulation may be identified in the various manners described above, such as in FIG. 4, including but not limited to parsing a bar code or obtaining user input to identify the nail formulation.

At block 506, an ultraviolet (UV) light assembly is configured to cure an application of the nail formulation on the user. Configuring the UV light assembly may include actions such as identifying and activating a subset of UV lights in the UV light assembly that have wavelengths appropriate to efficiently cure the nail formulation.

In a further embodiment, the method 500 includes transmitting the user identity and an identification of the nail formulation to a remote data store. The remote data store may include information such as user data, nail formulation data, sales data, and other marketing, financial, or product data. Using the information, an organization may be able to derive sales trends, usage trends, or other information to better design and market products. The data may also be used to market cross-sells or up-sells to a user.

In a further embodiment, the method 500 includes obtaining a location of the computer and transmitting the location to a remote data store. The location may be obtained by accessing a global positioning systems (GPS) unit in the computer. Alternatively, the location may be obtained by triangulating cellular tower locations or by using a cellular tower signal strength in order to determine an approximate location.

In a further embodiment, the method 500 includes receiving location-specific data from the remote data store and presenting at least a portion of the location-specific data to the user. In an embodiment, the location-specific data comprises an advertisement for an establishment in proximity to the user. For example, while a user is applying a nail gel formulation at a coffee shop, the user may be informed of a bookstore that has a book in stock that the user had previously indicated interest in. Other location-specific information may include data such as traffic data, weather data, or the like.

### Hardware Platform

Embodiments may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

Examples, as described herein, can include, or can operate on, logic or a number of components, modules, or mechanisms. Modules are tangible entities (e.g., hardware) capable of performing specified operations and can be configured or arranged in a certain manner. In an example, circuits can be arranged (e.g., internally or with respect to external entities such as other circuits) in a specified manner as a module. In an example, the whole or part of one or more computer systems (e.g., a standalone, client or server computer system) or one or more hardware processors can be configured by firmware or software (e.g., instructions, an application portion, or an application) as a module that operates to perform specified operations. In an example, the software can reside on a machine-readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor can be configured as respective different modules at different times. Software can accordingly configure a hardware processor, for example, to constitute a particular module at one instance of time and to constitute a different module at a different instance of time.

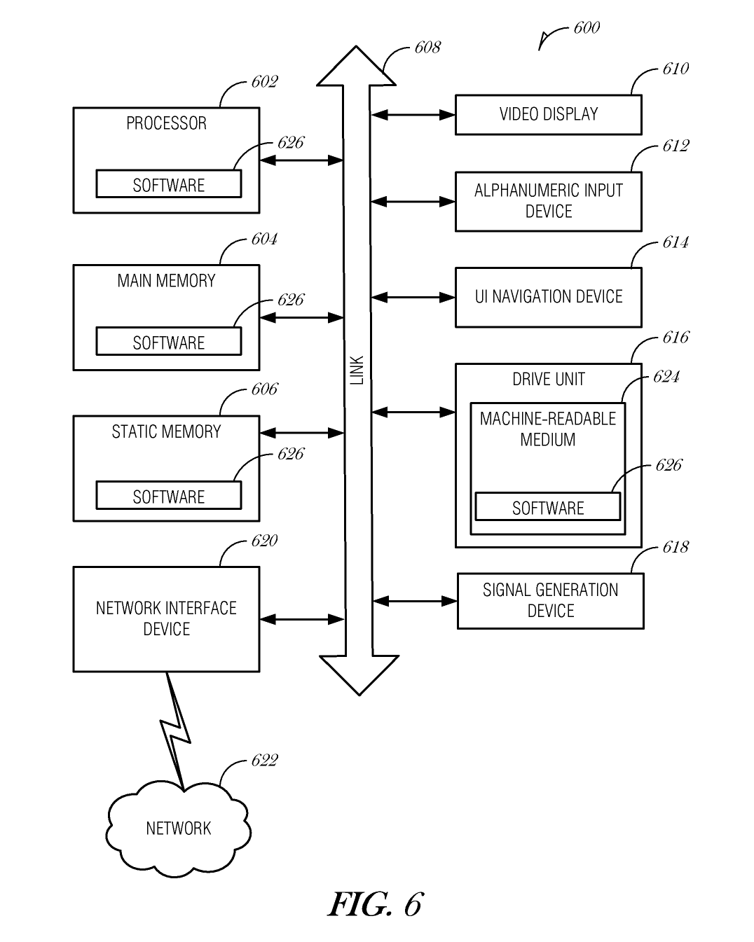

FIG. 6 is a block diagram illustrating a machine in the example form of a computer system 600, within which a set or sequence of instructions may be executed to cause the machine to perform any one of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Example computer system 600 includes at least one processor 602 (e.g., a central processing unit (CPU), a graphics processing unit (GPU) or both, processor cores, compute nodes, etc.), a main memory 604 and a static memory 606, which communicate with each other via a link 608 (e.g, bus). The computer system 600 may further include a video display unit 610, an alphanumeric input device 612 (e.g., a keyboard), and a user interface (UI) navigation device 614 (e.g., a mouse). In one embodiment, the video display unit 610, input device 612 and UI navigation device 614 are incorporated into a touch screen display. The computer system 600 may additionally include a storage device 616 (e.g., a drive unit), a signal generation device 618 (e.g., a speaker), a network interface device 620, and one or more sensors (not shown), such as a global positioning system (GPS) sensor, compass, accelerometer, or other sensor.

The storage device 616 includes a machine-readable medium 622 on which is stored one or more sets of data structures and instructions 624 (e.g., software) embodying or utilized by any one or more of the methodologies or functions described herein. The instructions 624 may also reside, completely or at least partially, within the main memory 604, static memory 606, and/or within the processor 602 during execution thereof by the computer system 600, with the main memory 604, static memory 606, and the processor 602 also constituting machine-readable media.

While the machine-readable medium 622 is illustrated in an example embodiment to be a single medium, the term “machine-readable medium” may include a single medium or multiple media (e.g., a centralized or distributed database, and/or associated caches and servers) that store the one or more instructions 624. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 624 may further be transmitted or received over a communications network 626 using a transmission medium via the network interface device 620 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi, 3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

Although embodiments have been described with reference to specific example embodiments, it will be evident that various modifications and changes may be made to these embodiments without departing from the broader spirit and scope of the disclosure. Accordingly, the specification and drawings are to be regarded in an illustrative rather than a restrictive sense.

The Abstract is provided to allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A lightbar, comprising:
a detachable ultraviolet (UV) lightbar comprising a plurality of UV lights with at least two of the plurality of UV lights having different UV light output; and
a connector for connection to a power supply,
wherein the detachable UV lightbar is controlled by a controller connectably attachable to the connector, the controller configured to control the plurality of UV lights in a manner to cure a nail gel preparation.

2. The lightbar of claim 1, wherein at least one of the plurality of UV lights is a light-emitting diode (LED) light.

3. The lightbar of claim 1, wherein the plurality of UV lights comprise a first UV LED light operable to output a 395 nm wavelength and a second UV LED light operable to output a 365 nm wavelength, and wherein the controller operates the first or second UV LED according to the nail gel preparation being cured.

4. The lightbar of claim 1, wherein at least one of the plurality of UV lights is a cold cathode light.

5. The lightbar of claim 1, wherein the at least one of the plurality of UV lights is a compact fluorescent light.

6. The lightbar of claim 1, wherein the controller is integrated with a mobile electronic device.

7. The lightbar of claim 6, wherein the mobile electronic device incorporates the power supply.

8. The lightbar of claim 1, wherein the controller is further configured to access content and cause at least a portion of the content to be displayed to a user of the lightbar.

9. The lightbar of claim 8, wherein the content includes at least one of an advertisement or an instruction.

10. The lightbar of claim 8, wherein the content is accessed from over a network.

11. The lightbar of claim 10, wherein the network comprises a wide-area network.

12. A method for curing a nail gel preparation comprising:
identifying by a processing device, the nail gel preparation; and
configuring an ultraviolet (UV) light assembly to cure the nail gel preparation.

13. The method of claim 12, wherein identifying the nail gel preparation comprises:
obtaining an image of a product container for the nail gel preparation;
identifying a product code from the image; and
using the product code to determine a curing configuration for the nail gel preparation;
and wherein configuring the UV light assembly comprises using the curing configuration.

14. The method of claim 13, wherein obtaining the image is performed with a built-in camera in the processing device.

15. The method of claim 13, wherein identifying the product code from the image comprises identifying and parsing a bar code contained in the image to obtain the product code.

16. The method of claim 13, wherein using the product code to determine a curing configuration comprises:
transmitting the product code to a remote data store with a query to obtain the curing configuration; and
receiving the curing configuration from the remote data store.

17. The method of claim 13 wherein the curing configuration comprises a cure time.

18. The method of claim 13, wherein the curing configuration comprises a target wavelength.

19. The method of claim 12, wherein identifying the nail gel preparation comprises receiving user input to identify the nail gel preparation.

20. The method of claim 12, further comprising displaying a presentation to a user of the processing device substantially contemporaneously with curing the nail gel preparation.

21. The method of claim 20, wherein the presentation comprises a timer, the timer indicating an approximate time left to cure the nail gel preparation.

22. The method of claim 20, wherein the presentation comprises at least one of: an advertisement or a tip.

23. A non-transitory computer-readable medium comprising instructions, which when executed on a computer, cause the computer to:
present a login interface to obtain a user identity of a user of the computer;
identify a nail formulation; and
configure an ultraviolet (UV) light assembly to cure an application of the nail formulation on the user.

24. The non-transitory computer-readable medium of claim 23, further comprising instructions to:
transmit the user identity and an identification of the nail formulation to a remote data store.

25. The non-transitory computer-readable medium of claim 23, further comprising instructions to:
obtain a location of the computer; and
transmit the location to a remote data store.

26. The non-transitory computer-readable medium of claim 25, further comprising instructions to:
receive location-specific data from the remote data store; and
present at least a portion of the location-specific data to the user.

27. The non-transitory computer-readable medium of claim 26, wherein the location-specific data comprises an advertisement for an establishment in proximity to the user.
